(19) United States
(12) Patent Application Publication
(10) Pub. No.: US 2012/0211959 A1
(43) Pub. Date: Aug. 23, 2012

(54) STABILIZER FOR A MOTOR VEHICLE

(75) Inventors: Ullrich Hammelmaier, Paderborn (DE); Rodscha Drabon, Salzkotten (DE); Christian Howe, Paderborn (DE); Sebastian Saggel, Paderborn (DE); Johannes Böke, Blomberg (DE)

(73) Assignee: Benteler Automobiltechnik GmbH, Paderborn (DE)

(21) Appl. No.: 13/214,666

(22) Filed: Aug. 22, 2011

(30) Foreign Application Priority Data
Aug. 25, 2010 (DE) 10 2010 035 524.0

(51) Int. Cl. B60G 21/055

(52) U.S. Cl. 280/124.106

(57) ABSTRACT

A stabilizer for installation onto a motor vehicle axle includes a stabilizer back and two legs which are connected to the stabilizer back to form a U-shaped, or C-shaped, or other suitably shaped structure. The stabilizer back is made of a composite material such as fiber composite, e.g. of glass fibers, carbon fibers, basaltic fibers, and metallic fibers.

### CROSS-REFERENCES TO RELATED APPLICATIONS

This application claims the priority of German Patent Application, Serial No. 10 2010 035 524.0, filed Aug. 25, 2010, pursuant to 35 U.S.C. 119(a)-(d), the content of which is/are incorporated herein by reference in its entirety as if fully set forth herein.

### BACKGROUND OF THE INVENTION

The present invention relates to a stabilizer for installation onto a motor vehicle axle.

The following discussion of related art is provided to assist the reader in understanding the advantages of the invention, and is not to be construed as an admission that this related art is prior art to this invention.

Stabilizers in the automobile industry involve torsion springs for roll stabilization of the superstructure of motor vehicles and are installed between the wheels onto an axle of the motor vehicle. As wheels of an axle mutually deflect, the stabilizers distribute the axle load and provide even axle load distribution. In this way, the performance of the motor vehicle is positively affected so as to maintain the adhesion coefficients of the wheels arranged on an axle substantially identical at a desirable level.

Conventional stabilizers are manufactured as solid rods or as tubular rods of metallic materials, e.g. steel. Depending on the required spring rate, the components are dimensioned in light of service life and stiffness demands. When high stiffness is required, the use of metallic materials inherently causes a high overall weight of the structure. This, however, is in conflict with current demands to reduce the total weight of a motor vehicle so as to minimize fuel consumption and CO₂ emission. Thus, conventional stabilizers suffer shortcomings because a low weight results either in a short service life or falls short to meet stiffness requirements.

It would therefore be desirable and advantageous to provide an improved stabilizer for a motor vehicle to obviate prior art shortcomings and to attain a low component weight while meeting high stiffness requirements.

### SUMMARY OF THE INVENTION

According to one aspect of the present invention, a stabilizer for installation onto a motor vehicle axle includes a stabilizer back made of a composite material, and two legs connected to the stabilizer back. A stabilizer according to the present invention may have a substantially U-shaped configuration, although it may also be configured in the shape of a C or of any other suitable shape. By making the stabilizer back of composite material, it becomes possible to tailor the torsion behavior and thus the stiffness of the stabilizer to the need at hand while at the same time provide a small, specific overall structural weight. The geometrical moment of inertia and the stiffness behavior, in particular of the stabilizer back, can thus be best suited to the demands at hand by suitably selecting the composite material and the manner by which the composite material is produced. For example, when a sports car is involved, a stiffness can be realized that is particularly high so as to attain little roil of the superstructure while at the same time realizing a very small specific weight, when compared to conventional stabilizers of metallic material.

According to another advantageous feature of the present invention, the legs of the stabilizer may be made of composite material. In particular, when fiber composites are involved, the effectiveness and thus the stiffness can be optimized. For example, the fibers of a fiber composite for the stabilizer back may be oriented such as to attain a particularly high section modulus against torsion, whereas the fibers of the fiber composite for the legs may be oriented in a different direction to attain a particularly high section modulus against bending.

In accordance with the present invention, a stabilizer can be produced which is best suited to the application at hand and is of small weight, while being able to enhance the driving dynamics of a motor vehicle and to reduce fuel consumption and CO₂ emission as a result of the low overall weight. The low weight further has the benefit that the proportion of unsprung wheel masses decreases so that the overall agility of the motor vehicle is substantially improved.

The use of a composite material provides also the possibility to shape a stabilizer of highly complex, geometric dimensions or configurations. In particular in the area of the underfloor of a motor vehicle, the demands to provide flexibility when configuring a stabilizer for a motor vehicle are strict. For example, suspension struts, driveshafts, transverse control arms, brakes, brake lines etc. provide only little space for installation of a stabilizer. Using composite material allows a stabilizer to be configured in an attachment zone of the legs in the form of a serpentine or the like.

According to another advantageous feature of the present invention, the legs of the stabilizer may be made of a metallic material. For example, while the stabilizer back is made of composite material, the legs may be made of an aluminum material or steel materials or suitable alloys. Manufacturing the stabilizer as hybrid structure has again the benefit to provide the stabilizer with added degrees of freedom by appropriately selecting the material for the individual functional parts. Decoupling the individual functional parts thus ensures to best suit the respective functional parts to the satisfy stiffness considerations, torsion behavior, and overall weight considerations.

According to another advantageous feature of the present invention, the composite material may involve a fiber composite which can be made of glass fibers, carbon fibers, basaltic fibers, or also metallic fibers. Fiber composite is characterized by containing at least a resin or an adhesive to provide a bond with the fiber material. This is advantageous because stiffness requirements can be met by suitable orientation of the fiber layers or also of the fibers. Also, through proper selection of the resin or also fabric layers, for example through arrangement of the weft threads and the warp threads, the material can be made elastically deformable and be made stiffer. In addition, complex shapes of a stabilizer and variation in the wall thickness can be attained. Especially, when considering novel winding techniques in the field of fiber composites, stabilizers according to the present invention can be made in a particularly cost-efficient manner.

According to another advantageous feature of the present invention, the stabilizer back or also the legs may be made entirely of a fiber composite. Thus, the stabilizer parts can be suited to the situation at hand but made from one material

According to another advantageous feature of the present invention, the stabilizer back or also the legs may be made of a metallic material which is wrapped by a fiber composite. This approach allows existing stabilizers to be modified to enhance stiffness in some regions thereof through reinforcement with fiber composite. The thus produced hybrid structures also allow the application of new materials that so far have not been considered for constructing stabilizers. For example, it becomes possible to manufacture stabilizer portions of certain light metals and to reinforce them with fiber composite in such a manner as to include plastic or elastic deformations with desired properties. As a result, new options become available for improving moment of inertia, section modulus, and thus vehicle handling while at the same lowering the overall weight.

According to another advantageous feature of the present invention, the stabilizer back and the legs can be coupled to one another at coupling sites with the fiber composite by a formfit, interference fit, material joint, or combinations thereof. In this way, various materials can be coupled to one another in such a way as to satisfy the respective stiffness demands and also demands on the coupling sites as far as forces to be transmitted and service life are concerned by the use of fiber composite and contained resin. Thus, it is thus possible within the scope of the present invention, to establish an interference fit or friction fit of stabilizer back with a leg through shrinkage for example.

According to another advantageous feature of the present invention, a feather key may be provided to establish a formfitting connection, or to bond the stabilizer back to the legs, or vice versa, to establish a material joint. At least one area of the legs may hereby be wrapped by the composite material at the coupling site. This allows production of a hybrid structure to form a stabilizer in a particularly cost-efficient manner or to establish a connection of particularly high strength and long service life when the fiber composite is wrapped around and then cured.

According to another advantageous feature of the present invention, at least one area of the legs may be bonded with the composite material. The bond may be realized for example by the resin of the fiber composite or by using a separate adhesive. This also enables an increase in versatility of selectable and usable materials for producing a stabilizer which may have portions made of different parts.

According to another advantageous feature of the present invention, a formfitting element may be arranged between the fiber composite and the legs to establish a formfit. This also allows production of individual components separately and then to couple them in a form fitting manner by connecting the legs with the stabilizer back through insertion of rivet pins. It is also conceivable within the scope of the invention, to insert the formfitting elements beforehand, for example into the legs, and then to wrap with fiber composite for producing the stabilizer back. This results in a combination of a form fit and material joint. Using heat treatment or the like further results in an interference fit through shrinkage of the fiber composite.

According to another advantageous feature of the present invention, the stabilizer may be provided with an active adjustment element, with the stabilizer back advantageously being made of two parts for attachment to the adjustment element. Advantageously, the stabilizer back is made of approximately of two halves to attain the desired vehicle handling of the motor vehicle. Of course, other ratios are also conceivable such as 90/10, 70/30, or 60/40, for example. Selection of an appropriate ratio is also determined by the available installation space in the motor vehicle being designed.

According to another advantageous feature of the present invention, attachment flanges may be provided to connect the stabilizer back or stabilizer back halves to the adjustment element, for example through bolting. The attachment flanges can be made in one piece with the stabilizer back made of fiber composite, i.e. the attachment flanges are also made of fiber composite.

According to another advantageous feature of the present invention, the attachment flanges may be made of metallic material, e.g. steel or light metal, and coupled with the stabilizer back by formfit, interference fit, material joint, and combinations thereof.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of one embodiment of a stabilizer according to the present invention for installation in a motor vehicle;

FIG. 2 is a schematic illustration of another embodiment of a stabilizer according to the present invention with active adjustment element for installation in a motor vehicle; and

FIG. 3 is a schematic detailed cutaway view of a fiber winding of a fiber composite.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

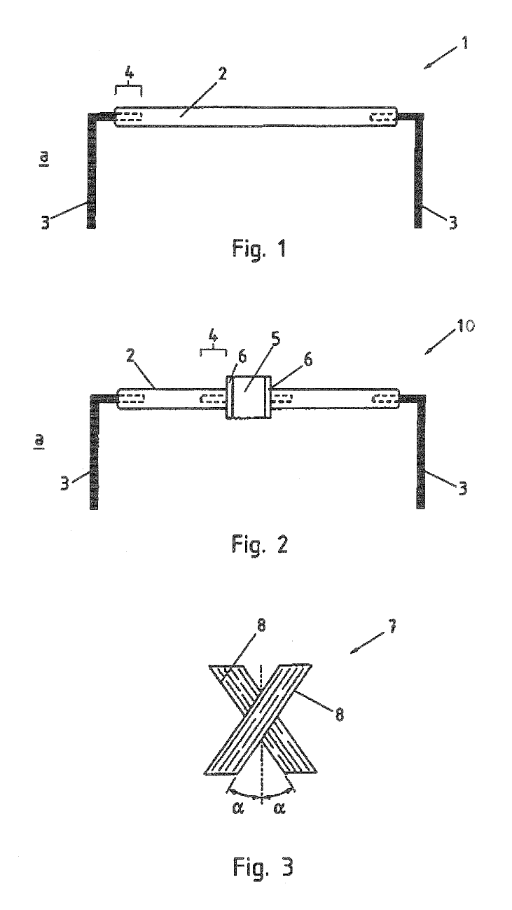

Turning now to the drawing, and in particular to FIG. 1, there is shown one embodiment of a schematic illustration of a stabilizer according to the present invention, generally designated by reference numeral 1 for installation in a motor vehicle, not shown in greater detail. The stabilizer 1 is comprised of a stabilizer back 2 and two legs 3 coupled to the outside of the stabilizer back 2. The legs 3 are embraced by the stabilizer back 2 at coupling sites 4 and connected thereto by formfit, interference fit, and/or material joint.

FIG. 2 shows a schematic illustration of another embodiment of stabilizer 1 according to the present invention. Parts corresponding with those in FIG. 1 are denoted by identical reference numerals and not explained again. The description below will center on the differences between the embodiments. In this embodiment, the stabilizer back 2 is made of two parts and provision is made for an active adjustment element 5 arranged approximately in midsection between the two parts of the stabilizer back 2. Legs 3 are respectively coupled to the outside of the parts of the stabilizer back 2. The active adjustment element 5 is attached to the stabilizer back 2 by attachment flanges 6 of the stabilizer back 2. The attachment flanges 6 are coupled to the parts of the stabilizer back 2 in a same manner as the connection of the legs 3 at the coupling sites 4.

FIG. 3 shows a schematic cutaway view of a detail 7 of a fiber composite web. By changing the angle α and thus the orientation of the individual fibers 8, the respective section modulus of the manufactured fiber composite structure can be influenced.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A stabilizer for installation onto a motor vehicle axle, comprising:
a stabilizer back made of a composite material; and
two legs connected to the stabilizer back.

2. The stabilizer of claim 1, wherein the legs are made of composite material.

3. The stabilizer of claim 1, wherein the legs are made of a metallic material.

4. The stabilizer of claim 1, wherein the composite material is a fiber composite.

5. The stabilizer of claim 4, wherein the fiber composite is a material selected from the group consisting glass fibers, carbon fibers, basaltic fibers, and metallic fibers.

6. The stabilizer of claim 1, wherein the stabilizer back is made entirely of a fiber composite.

7. The stabilizer of claim 2, wherein the composite material for the stabilizer back and the legs is a fiber composite with fibers of the fiber composite for the stabilizer back oriented in one direction, and with fibers of the fiber composite for the legs oriented in another direction.

8. The stabilizer of claim 1, wherein the stabilizer back is made of a metallic material which is wrapped by a fiber composite.

9. The stabilizer of claim 4, wherein the stabilizer back and the legs are coupled to one another at respective coupling sites with the fiber composite by a connection selected from the group consisting of formfit, interference fit, material joint, and combinations thereof.

10. The stabilizer of claim 9, wherein at least one area of the legs is wrapped by the composite material at the coupling sites.

11. The stabilizer of claim 4, wherein at least one area of the legs is bonded with the composite material.

12. The stabilizer of claim 4, further comprising a formfitting element arranged between the stabilizer back of fiber composite and the legs.

13. The stabilizer of claim 12, wherein the formfitting element is a rivet pin.

14. The stabilizer of claim 1, further comprising an active adjustment element, said stabilizer back being made of two parts for attachment to the adjustment element.

15. The stabilizer of claim 14, further comprising attachment flanges to respectively connect the parts of the stabilizer back to the adjustment element.

16. The stabilizer of claim 15, wherein the attachment flanges are made in one piece with the stabilizer back and made of composite material.

17. The stabilizer of claim 14, wherein the attachment flanges are made of metallic material and coupled with the stabilizer back by a connection selected from the group consisting of formfit, interference fit, material joint, and combinations thereof.
